(19) United States
(12) Patent Application Publication
(10) Pub. No.: US 2007/0144381 A1
(43) Pub. Date: Jun. 28, 2007

(54) Covering for printing machines

(76) Inventors: Heinz W. Lorig, Legden (DE); Stephan Lorig, Legden (DE); Joan-Dirk Kumpers, Rheine (DE)

Correspondence Address: FAY SHARPE LLP, 1100 SUPERIOR AVENUE, SEVENTH FLOOR, CLEVELAND, OH, 44114, US

(21) Appl. No.: 10/592,987

(22) PCT Filed: Mar. 18, 2005
(86) PCT No.: PCT/EP05/02923

§ 371 Date: Sep. 15, 2006

(30) Foreign Application Priority Data
Mar. 18, 2004 (DE) 2004 004 375.0

(51) Int. Cl. B41F 13/10

(52) U.S. Cl. 101/375

(57) ABSTRACT

The invention relates to a sleeve for mounting on carrier cylinders of printing machines, with two flange rings 11, 12 on the ends, on which a cylindrical outer sleeve wall 20 and an inner sleeve wall 30 are supported at a distance from each other. In order to create a sleeve, more particularly an adapter sleeve, that can be easily mounted on and removed from carrier cylinders, is cost-effective to produce, and with a comparatively low weight allows extremely high printing qualities, it is envisaged in accordance with the invention that the external sleeve wall 20 comprises a fibre composite material with at least one layer of a carbon fibres-nonwoven sheet 21 and that between the two flange rings 11, 12 at least one support ring 40, 40A is provided that supports the outer sleeve wall 20, vis-à-vis the inner sleeve wall 30.

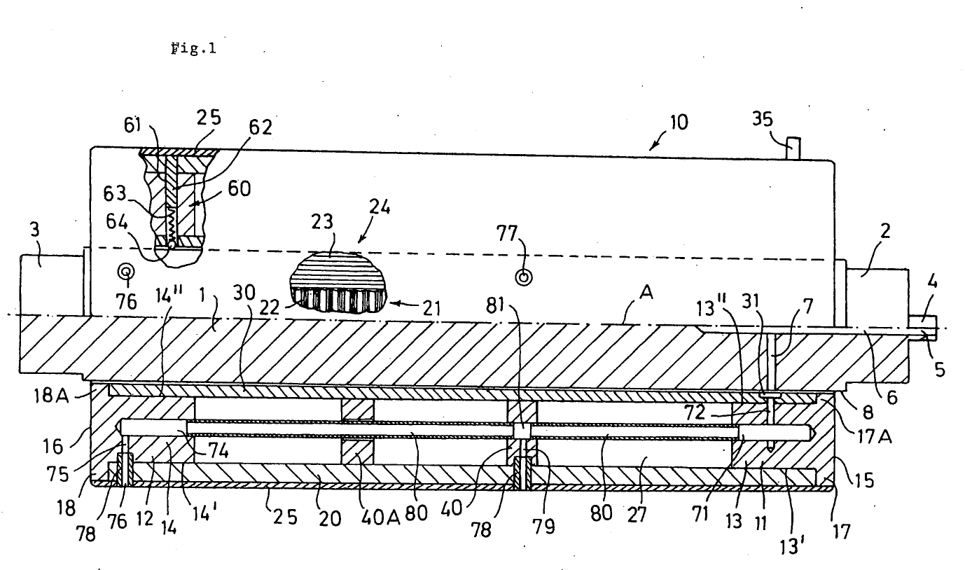

The invention relates to a sleeve for assembly on carrier cylinders of printing machines, with two flange rings on the ends of the sleeve on which a cylindrical outer sleeve wall and an inner sleeve wall are supported at a distance from one another.

The invention relates in particular to adapter sleeves for printing machines. In printing machines the carrier cylinders are often designed as air cushions onto which the adapter sleeves are axially pushed or are removed from them. With the compressed air system of the carrier cylinder the adapter or operating sleeve is expanded before assembly or disassembly so that during the pressurisation process it is held secured against rotation by pressing on the carrier cylinder. The use of adapter sleeves prevents the operating sleeves that are to be assembled on a carrier cylinder of a predetermined diameter having excessively large wall thicknesses, which would increase the acquisition costs of the operating sleeves and impair the achievable printing quality with the operating sleeves.

Adapter sleeves that can be adapted in a comparatively simple manner to the design and dimensions of carrier rollers and with which comparatively good printing qualities can be achieved are known, for example from DE 20012929 U1. The adapter sleeves comprise two non-compressible liner elements arranged at the ends of the adapter sleeves, the internal diameter of which, allowing for play and transition fitting, is greater than the external diameter of the carrier cylinder. The inner and outer sleeve walls, which consist of tubes, are fastened to the liner elements in such a way that in the assembly condition the inner sleeve wall is at a distance from the outer wall of the carrier cylinder which corresponds to the thickness of radially extending liner sections, whereby both liner elements have collar sections at their ends, on the outer surface of which the outer sleeve wall rests. The outer sleeve wall can be made of a fibre-reinforced synthetic material. Alternatively the outer sleeve wall can also be made of an aluminium tube or another bending-resistant material. The transition or pressing fit between the two end, non-compressible liner elements/flange rings and the external wall of the carrier cylinder can achieved by exploiting the temperature coefficient of expansion of the materials used for this during assembly, through hydraulic or pneumatic tensioning elements or through the use of piezo ceramics.

U.S. Pat. No. 4,794,858 discloses an adapter sleeve with two end flange rings and only one external sleeve element, whereby the chamber between the two flange rings and open to the surface area of the carrier cylinder is to be used to convey the compressed air system of the carrier cylinder. The rotationally stable fastening of the sleeve on the carrier cylinder is realised by way of hydraulic tensioning elements assigned to the carrier cylinder.

From EP 683046B1 is a sleeve for mounting on carrier cylinders of flexoprint machines in which the outer sleeve wall is separated from the inner sleeve wall by two flange rings forming an internally and externally sealed chamber, whereby at least one partial area of the inner sleeve wall is elastically deformable, and through the application of a suitable fluid to the chamber can be pressed against the outer casing of the pressure cylinder. The entire sleeve can be made of a composite material.

EP 1025996B1 shows a sleeve with an external casing of a carbon fibre composite material with a wound framework of carbon fibres, whereby the winding is such that the sleeve is self-supporting over the entire length of the sleeve and discs arranged at both ends are sufficient to keep the sleeve of carbon fibre windings at a distance from the carrier cylinder. The carbon fibre windings must provide the sleeve with such a high degree of integral rigidity that the sleeve can over its entire length, i.e. the distance between the two disks, withstand all radial forces occurring during printing. In the case of outer diameters of up to 400 mm the wall thickness of the sleeve provided with carbon fibre windings is up to 20 mm. By using a carbon fibre reinforced composite material for the sleeve a considerable reduction in weight can be achieved compared to sleeves with a metal casing.

The aim of the invention is to create a sleeve for printing machines, more particularly an adapter sleeve, which can be easily assembled on or dissembled from carrier cylinders, that is cost-effective to manufacture and which with a comparatively light weight allows extremely good printing quality.

In accordance with the invention it is envisaged that the outer sleeve wall is made of a fibre composite material with at least one layer of a carbon nonwoven-fibres sheet and that between the two flange rings there is at least one support ring for supporting the outer sleeve wall vis-à-vis the inner sleeve wall. The use of carbon fibres-nonwovens sheets instead of a windings with carbon fibre results in a considerable reduction in the manufacturing costs of the outer sleeve wall as appropriate carbon fibre sheets, more particularly carbon fibre sheets with a unidirectional arrangement of all the carbon fibres, can be purchased and further processed in prefabricated form. By arranging at least one, preferably several, support rings between the two flange rings, with an extremely low weight and, in particular, extremely small thickness of the outer sleeve wall, a high degree of intrinsic rigidity of the sleeve can be achieved over its length. Although the additional support rings increase the weight of the sleeve, due to the thinner required thickness of the outer sleeve wall permitted thereby, the result, with a low overall weight of the sleeve is a surprisingly high printing quality, which cannot be achieved with “self-supporting” outer sleeve walls that are only supported at the ends.

In a preferred embodiment several support rings are arranged or formed between the two flange rings. The number of support rings depends to a considerable extent on the number of layer of carbon nonwoven-fibres or carbon fibre sheets in the fibre composite material and the fibre orientation of the layers in question. In the preferred embodiment at least one carbon fibres-nonwoven sheet is envisaged in which the fibre orientation of the carbon fibres is 90° relative to the sleeve axis/carrier cylinder axis. This orientation brings about optimum rigidity properties for the radial forces to be absorbed during the printing process. Also, preferably, several layers of preferably unidirectional carbon fibres-nonwoven sheets are provided. The rigidity of the outer sleeve wall can be increased further if the fibre orientation of the carbon fibres of at least one layer of a carbon fibres-nonwoven-sheet is 45° relative to the sleeve axis. Several layers of carbon fibres-nonwoven-sheets can have the same fibre orientation. In the simplest embodiment the carrier fibres of the carbon fibre sheet can in principle have no or only small rigidity properties and can, for example, consist of a textile material such as sewing thread. In a particularly preferred form of embodiment the carrier fibre of the carbon fibres-nonwoven sheet exhibits sufficiently high rigidity properties, whereby the carrier fibre of the fibres-nonwoven sheet can, in particular, be a glass fibre. In the particularly preferred embodiment the outer sleeve wall consists of a glass-fibre/carbon fibres-nonwoven sheet hybrid. It is especially advantageous if, as is known, the carbon fibres in the carbon fibres-nonwoven sheet are arranged in bundles and the bundles are arranged relatively close to each other by way of the carrier fibres. Every, preferably, flat, strip-like bundle of carbon fibres than contains a number of individual filaments. Alternatively the outer sleeve wall can also comprise sheets with carbon fibres and glass fibres, whereby the sheets can be arranged with alternating fibre orientation. As a further alternative a winding surrounding the carbon fibre sheet(s) can be provided with a continuous carbon fibre in order to increase the intrinsic rigidity of the outer sleeve wall, or bidirectional carbon fibre-nonwoven sheets are used. The matrix in the fibre composite material in which the carbon fibres and, as the case may be, the other reinforcing fibre(s), are embedded, is preferably an ester, more particularly a vinyl ester. Alternatively a polyester or epoxy resin can be used.

Also preferably in the fiber-nonwoven sheets used in accordance with the invention, the fibres can lie in elongated form in one plane and fastened to each other with several knit threads. The sheets can also be made of several different raw materials and/or several different layers in terms of orientation and area weight. The carrier fibres, which together with the knit threads fasten the principal orientation direction fibres, can preferably also consist of polymer thread, glass fibre roving or plastic fibre rovings.

In all embodiments the outer surface of the sleeve is preferably formed of a function surface, whereby the function surface comprises in particular a coating with a metal such as steel, aluminium, nickel, chromium or copper, an elastomer or suchlike. In a particularly preferred embodiment the function surface is electrically conductive, with at least one discharge element to discharge electrostatic charges being arranged in the flange ring, which when assembled connects the function surface with the carrier cylinder. The discharge element can, for example, comprise a pressurised body, pretensioned with a pressure spring, whereby all function parts of the discharge element are electrically conductive.

In a particularly preferred embodiment the two flange rings have an end outer flange collar which projects annularly beyond an outer casing area of the flange ring on which the outer sleeve wall is supported and which delimits the outer sleeve wall at the end. It is of particular advantage if the two flange rings also have an end inner flange collar, whereby each inner flange collar, projects annularly over an inner wall surface of the flange ring on which wall surface the inner sleeve wall is supported and delimits the inner sleeve wall at the end. Both measures benefit the assembly of the flange ring, support ring and the two sleeve walls.

For carrier cylinders with a compressed air system it is particularly advantageous if at least one of the flange rings is provided with a boring system for the compressed air system of the carrier cylinder. The boring system in the flange ring preferably comprises at least one radial boring with an opening at the sleeve outer wall, whereby the boring system can also preferably have at least one axial boring which is connected with a supply channel opening into a radial boring in at least one of the support rings. The axial boring of the boring system in the flange ring can be connected with the supply channel in the support ring, more particularly via a pipeline. This has the advantage that the chambers formed between a flange ring and a support ring and/or between two support rings do not have to be hermetically sealed and that the connection between the flange rings and/or support rings and the sleeve walls are not subjected to the forces of the compressed air system. If several support rings are provided with supply channels and/or radial borings, the supply channels of different support rings are preferably connected to each other by way of further pipelines. In order to connect the boring system in the flange ring with the compressed air system of the carrier cylinder, the latter comprises in the particularly preferred embodiment a tap pipeline to the inner sleeve wall, whereby the latter is provided with a circumferential groove on the inside into which the tap pipeline opens.

Further advantages and embodiments are set out in the following description of an example of embodiment shown schematically in the single FIGURE.

In the single FIGURE, cut open in the lower half, an adapter sleeve 10 is shown mounted on a carrier cylinder designated 1 overall. The carrier cylinder 1 comprises at each of its two ends an axle journal 2 and 3, with which the carrier cylinder 1 can be borne in a printing machine, which is not shown. On the axle journal 2 of the carrier cylinder 1 there is a compressed air connection 4 with an air supply channel 5, which opens in an air channel 6 in the carrier cylinder 1 that is arranged centrically on the carrier roller/sleeve axle A. The air channel 6 extends axially at least as far as a transverse channel 7 in the carrier cylinder 1, which extends to the circumferential surface 8 of the carrier cylinder. Carrier cylinders for printing machines designed in this way are known in the prior art so that further explanations do not have to be given here.

The adapter sleeve 10 in accordance with the invention has at its ends a first flange ring 11 as well as a second flange ring 12, on which an inner sleeve wall 20 and an outer sleeve wall 20 are set and supported at a distance from each other. The adapter sleeve 10 essentially comprises the two end flange rings 11, 12, the two sleeve walls 20, 30 as well as several support rings 40 and/or 40A. These, along with the flange rings 11, 12, mutually support the two sleeve walls 20 and 30 thereby providing the outer sleeve wall 20 with sufficient intrinsic rigidity relative to the inner sleeve wall 30 and the circumferential surface 8 of the carrier cylinder 1 over the length of the sleeve 10 to absorb printing forces during printing. Both flange rings 11, 12 can preferably consist of comparatively dimensionally stable synthetic material. Both flange rings 11, 12 have a flange projection 13 and 14 respectively extending parallel to the sleeve axle A over several centimetres, over the outer surface area 13′ and 14′ of which at the end, outer end 15 and 16 respectively, an outer flange collar 17 and 18 respectively projects. The outer sleeve wall 20 is supported directly on the outer surface area 13′ and 14′ respectively of the flange projections 13, 14 of the two flange rings 11, 12 and is fastened to these is a rotationally stable manner, for example is glued thereto. The two flange collars 17 and 18 respectively are in contact at their end faces with the sleeve wall 14 and extend to its outer surface. The inner sleeve wall 30 is in contact with inner surface areas 13″ and 14″ respectively of the flange projections 13, 14, whereby an inner flange collar 17A and 18A respectively also projects radially inwards as a flange projection beyond the inner surface areas 13″, 14″ so that when the flange rings 11, 12 are assembled the inner sleeve wall 30 is also delimited at the end surface by the inner flange collars 17A and 18A respectively. The support rings 40, 40A are preferably arranged at a constant distance from each other and the flange rings 11, 12 over the length and the support rings 40, 40A can, in particular, consist of a dimensionally stable synthetic material. The support rings 40, 40A can also comprise preformed disks or be expanded on between the two sleeve walls 20, 30.

The inner sleeve wall 30 can be made of a thin-walled tube of metal or, preferably an elastically deformable synthetic material. In accordance with the invention the outer sleeve wall 20 consists of a fibre composite material with several reinforcing layer of a unidirectional carbon fibre-nonwoven sheet 21 with carbon fibres arranged in bundles 22, whereby in at least one layer the fibre orientation of the individual carbon fibres, as shown in the broken open section of the sleeve 10, are arranged perpendicular to the sleeve axle A so that the individual carbon fibres of the bundles 22 in the carbon fibre sheet 21 are arranged in the outer sleeve wall 30 in the manner of stiffening rings. The outer sleeve wall 20 is more particularly designed as a carbon fibre and glass fibre hybrid, whereby in addition to the carbon fibres-nonwoven sheet(s) 21 glass fibres 23 are embedded into the synthetic material matrix consisting, for example, of vinyl ester. The glass fibres 23 can, as the schematically shown example of embodiment, be embedded unidirectionally in a glass-fibre sheet 24 which surrounds the layers of carbon fibres-nonwoven sheets 21, or the glass fibres form the carrier fibres for the carbon fibre sheet 21. The fibre orientation of the glass fibres is preferably perpendicular to the carbon fibre bundles 22 in the carbon fibres-nonwoven sheet 21 and therefore parallel to the sleeve axis A. The outer sleeve wall 20 preferably contains up to ten layers of a carbon fibres-nonwoven sheet 21, whereby in some layers the fibre orientation can also be 45° relative to the sleeve axis A. The number of layers of carbon fibre sheets 21 and glass fibre sheets 24 and the thickness of the outer sleeve wall 20 are selected so that the outer sleeve wall 20 would normally bend under the radial forces present during printing if the outer sleeve wall 20 were not supported between the two flange rings 11, 12 by the additional support rings 40, 40A. The number of support rings 40, 40A is therefore determined by the length of the adapter sleeve 10 as well as the diameter and structure of the outer sleeve wall 20.

From the FIGURE it can also be seen that the adapter sleeve 10 is provided on the outer surface with a function surface 25 which extends over the entire length of the sleeve 10 and covers both the outer wall surface of the outer sleeve wall 20 and the outer surface of both flange collars 17, 19 on the flange rings 11, 12. The function surface 25 comprises a metal or elastomer coating. In a, more particularly conductive, function surface 25 a discharge element 60 is arranged preferably in one of the flange rings, in this case flange ring 12, which is arranged in a radial boring 61 and extends from the function surface 25 to beyond the inner sleeve wall 30. In a preferred embodiment the discharge element 60 has a sleeve with an electrically conductive base section 62 on which a spring 63 rests, with which a pressure element, preferably a sphere 64 is pushed through an opening in the inner sleeve wall 30 against the circumferential surface 8 of the carrier cylinder 1, so that a permanent electrical contact between the function surface 25 of the adapter sleeve 10 and the circumferential surface 25 of the carrier cylinder 1 is assured. Several discharge elements 60 can be distributed over the circumference or arranged in a distributed manner over the flange rings.

For mounting the adapter sleeve 10 on carrier cylinders 1 designed as air cylinders the sleeve is provided with an air conveyance system which in the illustrated example of embodiment include an axial boring 71 and a single feeder 72 in the flange ring 11, whereby the single feeder 72 opens into a circumferential groove 31 on the inside on the inner sleeve wall 30, which when the adapter sleeve 10 is mounted on the carrier cylinder 1 is directly opposite the transverse boring 7 in the carrier cylinder 1. In this way the compressed air introduced into the carrier cylinder 1 via the compressed air connection 4 can be directed into the air conveyance system in the adapter sleeve 10. As in the illustrated example of embodiment an operating sleeve is to be pushed onto the adapter sleeve 10 from the left end, an axial boring 74 and a radial boring 75 in the flange ring 12 on the other side are connected with the axial boring 71 in the flange ring 11. The conveying of the compressed air between the two flange rings 11, 12 or their axial borings 71, 74 takes place via a pipeline 80 that is here divided into several sections. This has the advantage that the chambers 27 formed between the two flange rings 11, 12 and the support rings 40, 40A positioned between them do not have to be made pressure-resistant to compressed air. In the illustrated example of embodiment at flange ring 12 several outlet openings 76 are arranged distributed around the circumference, whereby in the area of each of the outlet openings 76 a threaded screw 78 with a through hole can be screwed through the outer sleeve wall 20 into the web section 14 of the flange ring 12. Further outlet openings 77 can also be arranged in the area of one of more support rings 40, whereby then a radial boring 79 branches off from an axial air conveying channel 81 in the appurtenant support ring 40 and a threaded screw 78 with a through-hole is screwed through the sleeve wall 20 into the support ring 40. For positioning and orienting the operating sleeve carrying the printing motif the adapter sleeve 10 is provided with a dowel 35 at the opposite end.

For a person skilled in the art the above description suggests numerous modifications coming under the protective scope of the dependent claims. If the carrier cylinder is not designed as a compressed air cylinder, a compressed air connection can also be provided directly in one of the flange rings. If the operating sleeve is mounted from the side of the printing cylinder compressed air connection, it can be enough if only the adjacent flange ring and the first support ring adjacent thereto are provided with an air conveying system. The arrangement and number of carbon fibre sheets can be matched to the anticipated printing pressures and the number of support rings. The adapter sleeve 10 can be connected in a rotationally stable manner to the carrier cylinder in accordance with the air cushion principle or by other suitable means. For assembly in accordance with the air cushion principle, the inner wall, for example, can be compressible or the inner wall is elastic and in the area of the support rings further grooves are arranged, these inner groove having a diameter which, allowing for play, is matched to the outer diameter of the carrier cylinder.

1. Sleeve for mounting on carrier cylinders of printing machines with two flange rings at the ends, on which a cylindrical outer sleeve wall and an inner sleeve wall are supported at a distance from each other, wherein the outer sleeve wall (20) comprises a fibre composite material with at least one layer of a carbon fibres-nonwoven sheet (21), and wherein between the two flange rings (11, 12) at least one support ring (40, 40A) is arranged which supports the outer sleeve wall (20) vis-à-vis the inner sleeve wail (30).

2. Sleeve in accordance with claim 1, wherein several support rings (40, 40A) are arranged or formed between the two flange rings (11, 12).

3. Sleeve in accordance with claim 1, wherein a fibre orientation of carbon fibre of the at least one layer of the carbon fibres-nonwoven sheet (21) is 90° relative to the sleeve axis (A).

4. Sleeve in accordance with claim 1, wherein said at least one layer of carbon fibres-nonwoven sheet comprises several layers of unidirectional carbon fibres-nonwoven sheets (21), more particularly eight to fifteen layers of carbon fibre sheets.

5. Sleeve in accordance with claim 1, wherein a fibre orientation of carbon fibres of the at least one layer of carbon fibres-nonwoven sheet is 45° relative to the sleeve axis.

6. Sleeve in accordance with claim 3, wherein several layers of carbon fibres-nonwoven sheets have the same fibre orientation.

7. Sleeve in accordance with claim 1, wherein a carrier fibre of the carbon fibres-nonwoven sheet has low rigidity characteristics and/or consists of textile material.

8. Sleeve in accordance with claim 1, wherein a carrier fibre of the carbon fibres-nonwoven sheet has high rigidity characteristics and/or consists of a glass fibre.

9. Sleeve in accordance with claim 1, wherein the outer sleeve wall (20) comprises a carbon fibre-glass fibre hybrid and preferably comprises fibres-nonwoven sheets with carbon fibres and glass fibres.

10. Sleeve in accordance with claim 1, wherein the carbon fibres in the carbon fibre sheet (21) are arranged in bundles and the bundles (22) are arranged relative to each other by way of the carrier fibre.

11. Sleeve in accordance with claim 1, wherein a winding with carbon fibres surrounding the carbon fibre sheet(s).

12. Sleeve in accordance with claim 1, wherein the matrix in which the carbon fibre sheet is embedded comprises an ester, preferably a vinyl ester.

13. Sleeve in accordance with claim 1, further comprising a function surface (25), preferably designed as a coating, forming the outer surface of the sleeve, whereby the function surface (25) is preferably electrically conductive and at least one discharge element (60) for discharging electrostatic charges is arranged in one of the flange rings, which when assembled connects the function surface with the carrier cylinder.

14. Sleeve in accordance with claim 1, wherein the two flange rings (11, 12) have an end-side outer flange collar (17, 18) which annularly projects beyond an external surface area (13′, 14′) of the flange ring (11, 12), on which the outer sleeve wall (20) is supported, and delimits the external sleeve wall (20) at the end.

15. Sleeve in accordance with claim 1, wherein the two flange rings (11, 12) have an end-side inner flange collar (17A, 18A), whereby each flange collar (17A, 18A) annularly projects beyond an inner wall area (13″, 14″) of the flange ring (11, 12) on which the inner sleeve wall (39) is supported and delimits the inner sleeve wall (30) at the end.

16. Sleeve in accordance with claim 1, wherein at least one of the flange rings (11, 12) is provided with a boring system to act in conjunction with a compressed air system of the carrier cylinder (1), whereby preferably the boring system in the flange ring (12) has at least one radial boring (75) with an opening (76) on the sleeve outer wall and/or the boring system has at least one axial boring (71) that is connected to a supply channel, opening into a radial boring (79), in at least one support ring (40).

17. Sleeve in accordance with claim 16, wherein the axial boring (71) of the boring system in the flange ring (11) is connected with the supply channel (81) in the support ring (40) via pipeline (80) and/or the supply channels of different support rings are connected to each other by means of pipelines (80).

18. Sleeve in accordance with claim 17, wherein the boring system has a single feeder (72) to the inner sleeve wall (30) whereby the latter is provided with a circumferential groove (31) on the inner side, into which the single feeder (72) opens.

19. An adapter sleeve comprising:
first and second spaced-apart flange rings;
an inner sleeve wall connected to and extending between the first and second flange rings;
a cylindrical outer sleeve wall connected to and extending between the first and second flange rings and supported at a distance from the inner sleeve wall, said cylindrical outer sleeve wall comprising a fibre composite material comprising at least one layer of a carbon fibres-nonwoven sheet;
at least one support ring arranged between the inner and outer sleeve walls to support the outer sleeve wall relative to the inner sleeve wall.
